(19) United States
(12) Patent Application Publication
(10) Pub. No.: US 2017/0351818 A1
(43) Pub. Date: Dec. 7, 2017

(54) SYSTEM FOR TRACKING INJURIES OF ATHLETES

(71) Applicant: GREGORY KNOX MCGRATH, CINCINNATI, OH (US)

(72) Inventor: GREGORY KNOX MCGRATH, CINCINNATI, OH (US)

(21) Appl. No.: 14/830,784

(22) Filed: Aug. 20, 2015

Related U.S. Application Data
(60) Provisional application No. 62/156,881, filed on May 4, 2015.

(51) Int. Cl. G06F 19/00; G06F 17/30; G06Q 10/10

(52) U.S. Cl. CPC G06F 19/324; G06F 17/30979; G06Q 10/109; G06F 19/328

(57) ABSTRACT

The invention herein is a real-time tracking system of injuries that happen to athletes in practice and in games. More particularly, such injury data may be immediately inputted into a database that tracks such data, organizes it and provides statistically relevant information about such injury data.

### FIELD OF THE INVENTION

The invention herein is a real-time tracking system of injuries that happen to athletes in practice and in games. More particularly, such injury data may be immediately inputted into a database that tracks such data, organizes it and provides statistically relevant information about such injury data.

### BACKGROUND

Millions of people play organized sports in the world. At the professional level, health professionals stand at the ready to assist a player when he or she becomes injured. Serious teams have full time health staffs. These staffs maintain copious records of injuries to players on the team. Significant capital is provided to track such injuries and to offer healing to them when they occur. This approach is not the same for non-professional athletes, excluding larger university based programs, and certainly is not available for youth sports athletes.

In youth sports, injuries across a sport, school, or locale are rarely tracked in any meaningful way. Injuries at the youth level often slip into anecdote. Often, children who have suffered multiple injuries are unknown and misdiagnosis can occur. Though not professionals, youth athletes are legion. The need to track their injuries immediately and then later review them and the conditions under which they occur is paramount.

What is therefore needed is a robust, powerful system that allows for real-time tracking of injuries in the course of a game or practice. What is also needed is the ability to collate tracked data to a one or more central sources. Once collated, that data can be parsed to reveal any existing trends and also to alert key personnel to provide care or follow-up to a specific athlete or school training staff. Further, what is needed is an ability to discover statistically significant trends from collected, tracked data. All of these concerns and more shall be addressed by this invention.

### BRIEF SUMMARY OF THE INVENTION

Accordingly, the invention herein provides a system for tracking and analyzing youth sports injuries of youth in real time. The invention comprises a personal computer for collecting injury data; a database wirelessly connected to the personal computer; and an application on the personal computer. The application enables the collection of injury data the said database in real-time.

The database does not allow for the mere collection and storage of injury related data. It is a database that comprises one or more important algorithms. In one instance herein, the algorithm organizes and classifies received injury data. In another instance herein, an algorithm compares the injury data to other collected injury data. Importantly, one or more algorithms may be used to calculate statistically significant trends in collected injury data in real time.

The system may further comprise the ability to contact one or more health professionals at such collection of injury data depending upon the severity thereof. Ideally, the system will also track the treatment and final remediation of an injury to an injured player whose injury was first captured by the system. At the collection of injury data, the system may generate a schedule for the remediation of the injury. Such schedule generation would ideally be in close collaboration with a primary treating physician who is authorized to receive injury data for a particular player or players. Ideally, a treating physician can also receive said injury data in real time and respond upon receipt with questions, recommendations or a diagnosis.

The system herein may comprise a smartphone, a smart pad device, a laptop computer, a smart watch, a desktop computer, wearable technology and the like.

Collected injury data may be connectable to a specific injured person. This will depend upon permissions given for such connection by a parent, as in the case of a youth athlete, or one above the age of majority. The system herein is constructed in a manner in which full HIPAA compliance may be met.

Importantly, injury data may be transmitted to relevant third parties. Such third parties may include parents, youth sports organizations, a hospital, emergency medical personnel, one or more physicians, a school, an insurance company, a research organization and the like.

The system's database herein is the final repository of collected injury data. Such injury data may be treated in multiple ways. The system aggregates, analyzes, benchmarks and tracks injuries in real time. The system, at the database, also aggregates, analyzes, benchmarks and tracks injuries over time thereby providing historical analysis of such data from previously collected injury data in real time.

As historical correlations in injury data are made by the database, a youth health profile may be created. This health profile can be created for a particular sports program, a school, a region, an individual athlete, a coaching or training staff and/or any entity connected, no matter how tangentially, to an athlete injury whose injury has been logged in real-time.

The system is capable of tracking more than specific injury data. It can also track the context and conditions in which an injury has occurred. For example, such conditions include, but are not limited to, age of the athlete, gender of thereof, sport of the athlete, the date, the surface on which an injury occurred (e.g., basketball court, tennis court, football field, and the like), rainfall, humidity, temperature, game occurrence, practice occurrence, GPS location of the injury, and activity during the said injury occurred. This list is not exhaustive. In fact, a user may create new fields within the application in which to collect any and all relevant information pertaining to the occurrence of an athlete's injury.

The system, at the database, comprises one or more algorithms for determining trends in injury data by multiple injured youth. In other words, trends may be assessed with respect to players on the same team, in the same division, in the same league, within the same sports organization, in the same region, in the same state and nationally. The speed of the correlation of such data is limited only by the hardware used to calculate the relevant statistics to draw such trends.

Statistical and trending data may be output to a user's smart device or printed in hard copy to one or more designated printers. Electronic files in various forms may be created and then forwarded to one or more intended recipients. File types may include, but are not limited to, PDF file types, Word® file types, JPEG file types and more. The exact file type created forms no part of the invention. What is important is that a created file type is transferrable electronically and viewable by an intended recipient using conventional electronic means.

The system can create injury profiles of multiple items aside from the injury profile of a specific player. For example, a coach may enter this kind of query: “What is the injury profile of referee John Smith?” This question seeks to assess the likelihood of injury of a coaches' players who play in a game officiated by referee John Smith. Upon analysis of past injury data in game of which a referee has officiated, that referee can be assigned an easy to understand score—e.g., a value of 1 to 10—that communicates the probability of an injured player. A score of 1 to 3 would mean ‘not likely to be injured’; a score of 4-6 would mean ‘moderate likelihood of injury’; while a score of 7-10 would mean ‘high likelihood of injury’. A similar query could be: “What is the injury profile of Potomac football field?” Such a question would generate an injury score for the football field given the number of injuries recorded on the field in comparison to similarly situated football fields of the same type (grass or turf) in the immediate vicinity or at a distance established by the user (e.g., for turf fields within a thirty mile radius of Potomac football field, the field in question).

Such injury scoring by query can be applied to almost any injury related criteria or condition. For example, concerned persons may ask queries an receive an injury score for any of the following: team matchups; player matchups; game locale; practice locale; climate conditions; specific training regiments including drills; degree of hydration; and the like.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic of the invention discussed herein.

### DESCRIPTION OF THE INVENTION

Accordingly, the invention herein provides a system for tracking and analyzing youth sports injuries of youth in real time. The invention comprises a personal computer for collecting injury data; a database wirelessly connected to the personal computer; and an application on the personal computer. The application enables the collection of injury data the said database in real-time.

The database does not allow for the mere collection and storage of injury related data. It is a database that comprises one or more important algorithms. In one instance herein, the algorithm organizes and classifies received injury data. In another instance herein, an algorithm compares the injury data to other collected injury data. Importantly, one or more algorithms may be used to calculate statistically significant trends in collected injury data in real time.

The system may further comprise the ability to contact one or more health professionals at such collection of injury data depending upon the severity thereof. Ideally, the system will also track the treatment and final remediation of an injury to an injured player whose injury was first captured by the system. At the collection of injury data, the system may generate a schedule for the remediation of the injury. Such schedule generation would ideally be in close collaboration with a primary treating physician who is authorized to receive injury data for a particular player or players. Ideally, a treating physician can also receive said injury data in real time and respond upon receipt with questions, recommendations or a diagnosis.

The system herein may comprise a smartphone, a smart pad device, a laptop computer, a smart watch, a desktop computer, wearable technology and the like. Devices of the types useful herein include the APPLE® IPHONE®, ANDROID® smartphones, SAMSUNG® smartphones, APPLE® IPAD, ANDROID® tablet and pad devices, and the like. Obviously, this list is not exhaustive and includes all current technology of the like and as yet not contemplated technology useful for recording injury data by the system presented herein.

Collected injury data may be connectable to a specific identified injured person. This will depend upon permissions given for such connection by a parent, as in the case of a youth athlete, or one above the age of majority. The system herein is constructed in a manner in which full HIPAA compliance may be met.

Importantly, injury data may be transmitted to relevant third parties. Such third parties may include parents, youth sports organizations, a hospital, emergency medical personnel, one or more physicians, a school, an insurance company, a research organization and the like.

The system's database herein is the final repository of collected injury data. Such injury data may be treated in multiple ways. The system aggregates, analyzes, benchmarks and tracks injuries in real time. The system, at the database, also aggregates, analyzes, benchmarks and tracks injuries over time thereby providing historical analysis of such data from previously collected injury data in real time.

As historical correlations in injury data are made by the database, a youth health profile may be created. This health profile can be created for a particular sports program, a school, a region, an individual athlete, a coaching or training staff and/or any entity connected, no matter how tangentially, to an athlete injury whose injury has been logged in real-time.

The system is capable of tracking more than specific injury data. It can also track the context and conditions in which an injury has occurred. For example, such conditions include, but are not limited to, age of the athlete, gender thereof, sport of the athlete, the date, the surface on which an injury occurred (e.g., basketball court, tennis court, football field, and the like), rainfall, humidity, temperature, game occurrence, practice occurrence, GPS location of the injury, and activity during the said injury occurred. This list is not exhaustive. In fact, a user may create new fields within the application in which to collect any and all relevant information pertaining to the occurrence of an athlete's injury and the conditions in which an injury occurs.

The system, at the database, comprises one or more algorithms for determining trends in injury data by multiple injured youth. In other words, trends may be assessed with respect to players on the same team, in the same division, in the same league, within the same sports organization, in the same region, in the same state and nationally. The speed of the correlation of such data is limited only by the hardware used to calculate the relevant statistics to draw such trends.

Statistical and trending data may be output to a user's smart device or printed in hard copy to one or more designated printers. Electronic files in various forms may be created and then forwarded to one or more intended recipients. File types may include, but are not limited to, PDF file types, WORD® file types, JPEG file types and more. The exact file type created forms no part of the invention. What is important is that a created file type is transferrable electronically and viewable by an intended recipient using conventional electronic means.

The system can create injury profiles of multiple items aside from the injury profile of a specific player. For example, a coach may enter this kind of query: “What is the injury profile of referee John Smith?” This question seeks to assess the likelihood of injury of a coaches' players who play in a game officiated by referee John Smith. Upon analysis of past injury data in game of which a referee has officiated, that referee can be assigned an easy to understand score—e.g., a value of 1 to 10—that communicates the probability of an injured player. A score of 1 to 3 would mean ‘not likely to be injured’; a score of 4-6 would mean ‘moderate likelihood of injury’; while a score of 7-10 would mean ‘high likelihood of injury’. A similar query could be: “What is the injury profile of Potomac football field?” Such a question would generate an injury score for the football field given the number of injuries recorded on the field in comparison to similarly situated football fields of the same type (grass or turf) in the immediate vicinity or at a distance established by the user (e.g., for turf fields within a thirty mile radius of Potomac football field, the field in question).

Such injury scoring by query can be applied to almost any injury related criteria or condition. For example, concerned persons may ask queries an receive an injury score for any of the following: team matchups; player matchups; game locale; practice locale; climate conditions; specific training regiments including drills; degree of hydration; and the like.

The invention is a system that provides the ability to track injuries in real time via electronic means. Such tracking creates data that can then be added to a central database in mere seconds or moments. Newly tracked data can be tagged to a high degree of specificity; e.g., team, school, city, state, sport, gender, age, referee crew, time of day, day, weather, field (whether inside or outside), month, year, stadium and more. Such tracking is first done with human input through the use of a helpful web interface or application. The tracking can be done in real time through a personal handheld device, pad device or a computer like a desktop or a laptop.

A set of algorithms that determine all of the possible relevant statistical measures of the collected data have been created for use herein. For example, statistical information related to frequency of injury, gender of the injured, weather conditions in which injury occurred and much more can assessed. Such statistical assessments can then be communicated to coaching staffs, schools, insurance providers, doctors, hospitals, governing organizations, the media and more. Heretofore unknown trends that today escape scrutiny can be discovered. For example, it can now be discovered that a particular officiating crew for a youth football league is responsible for 30% more injuries than any other crew. If known, then a league can remediate as desired. This level of granularity is currently unachievable since no other like systems exist, and certainly not in real time with such data.

The system has additional inventive components. It may also operate as part of a sports management solution that includes scheduling, standings, statistics noted hereinabove and also play related statistics as well. Thus, the solution provided herein is holistic for the play, preparation and injury assessment of athletes.

In practice, data is entered into the system via an interactive user interface that features 3D, 4D and/or holographic images of the human body. By clicking on the area of injury, screens populate menus with the appropriate injury data to be tracked and do so with a click on the menu. Ideally, the system requires a double validation of the data as well as a minimum of weekly input by each administrator so that all injuries are reported daily, weekly, another user inputted time period (e.g., every 2-3 days) or there is an affirmation of no injuries that week. This approach allows any person regardless of their medical background to easily input a received injury for a latter diagnosis as well as allow for a clinical quality collection of sports injury data.

After setup, the system will know the sport, age, sex, league, organization and coach with no recurring input. The system will track injuries on an anonymous or identified person basis from initial sports participation in pre-K through adult participation, and will track absentees to practices and games. By adding the schedule of attended games and schedules, the system can remain real-time accurate for each athlete on a team and for a team itself. By the term “anonymous person” it is meant herein that no name or other identifying information for a player is either a) provided into the system or b) the system is directed by a user to shield identifying information so that any output regarding the injury is held in an anonymous state, such injured person being therefore unknown. By the term “identified person” it is meant herein that identifying information for an injured person has been added to the system and that his or her injury is attached to a known person for outputs of information regarding the injury.

The system will then analyze collected data to identify injury related trends. This trend data can then be provided on demand as is suitable. Importantly, the system also maintains privacy of information as requested. Importantly, statistical analysis of all collected data that is then transformed and transmitted to key stakeholders will be provided by the invention herein. Such discovered data trends include, but are not limited to, ratios of injuries that are occurring based upon variables that include sport type, age, location, gender, venue, organization, coach, weather, practice or game, type of injury, how injury occurred, treatment of injury, therapy after treatment, outcome, performance after injury and more. Since many youth sports have both an in season component and an out of season training component, data can also be collected during out of season training to draw correlations, if any, that exist between off seasons training and in-season performance and/or injury occurred. For example, a stakeholder might need to know whether athletes who trained more during, say, off season weightlifting remain healthier than athletes who weight lift less for the same sport and whether there is an in-season performance correlation.

The system will both aggregate injury data nationally and internationally on an anonymous basis as well as to be able to track the injury, treatment, therapy and outcome history of individual youth athletes throughout their life. The system will allow for the analysis, benchmarking and historical tracking of youth sport injuries and what treatments and therapies have which specific effects on outcomes. The system will provide leadership of each organization using the system with real-time reporting as to which administrators are current with their input as well as with the full analytical reports they have requested.

On any given team, the primary responsibility for injury reporting belongs to a coaching staff and the head coach in particular. Using this system, such coaches can be held accountable by a sports league, insurance carrier, school or other interested relevant third party by statistically comparing coaches to one-another. This fosters accountability as to injury reporting; i.e., whether a coach's reporting meets or exceeds the mean expected amongst peers. Coach information with respect to history of injuries and reporting of other coaches can be assessed and then used to determine possible lack of reporting. For example, if a coaching staff exists in a league in which most coaches are compliant in their reporting duties, the system will be able to spot missed reporting from a coaching staff that appears to be out of compliance. If the average of injuries per team for that league is 2.5 per game event and 1.5 per practice but Coach A's averages are far below league averages, that could indicate a lack of reporting on the part of Coach A and his staff. Injury data may be entered into the system via a coach or some other designee, e.g., a team mom, physician or trainer. The system is intuitive and user friendly. Training to use the system for the input of injury data is minimal.

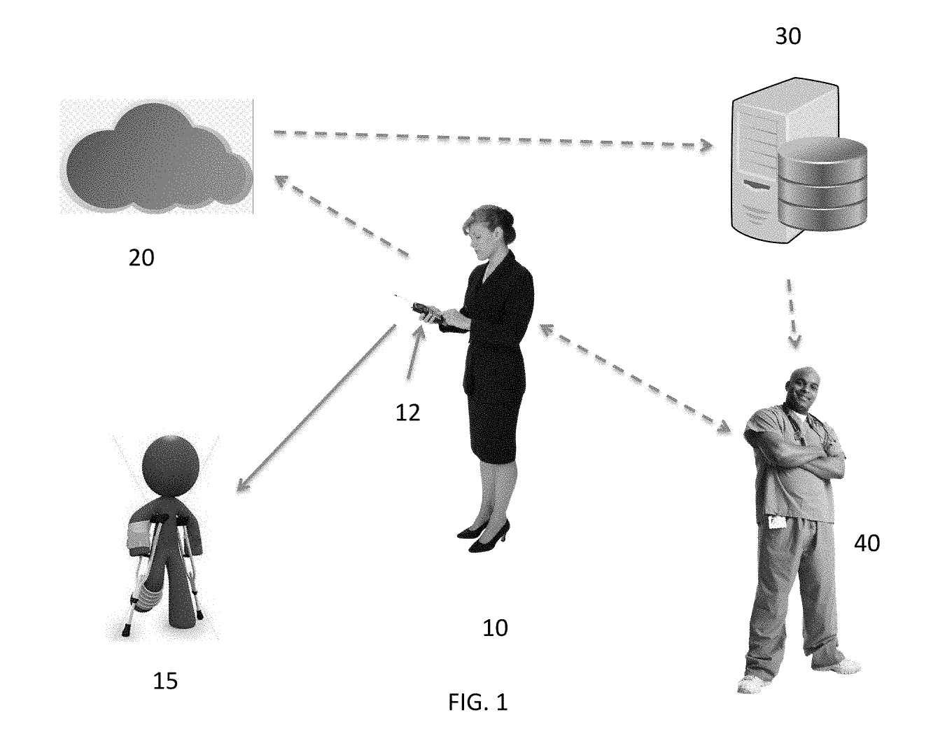

FIG. 1 provides a schematic of the invention herein. Recorder 10 (as in the recorder of injury data) is shown viewing the injury of an injured person 15 (i.e., an injured player). Using one of the devices described herein, e.g., a smartphone, recorder 10 records the nature of an injury in smart device 12 shown herein. Recorder 10 need not be a medical professional to describe an injury. Prompts and questions within the application of the invention used on smart device 12 are provided whereby a witnessed trauma may be properly described. Also, Recorder 10 may take pictures of an injury and use such in addition to or in place of text information about an injury.

Once data is collected into the application by smart device 12, it is then stored wirelessly into cloud 20. By the term “cloud” it is meant herein a remote network of computer servers and other devices that make up the Internet, such servers being accessible wirelessly and by wired access. Cloud 20, an assembly of devices including one or more servers, then stores received data into database 30. Cloud 20 and database 30 may represent one or more servers that receive and store received data. They may be different servers for the proscribed purposes. Such servers of the type contemplated herein include any of the known servers manufactured and sold by NEC®, ACER®, INTEL®, IBM®, DELL®, ORACLE®, CISCO® and HEWLETT-PACKARD®. This list is not exhaustive and includes servers of suitable type made by server manufacturers.

Data stored at database 30 is then analyzed, organized and treated analytically according to the one or more algorithms operable at database 30. One or more algorithms at database 30 may provide for immediate or semi-immediate communication of an injury to medical personnel 40. Medical personnel 40 as shown herein may be a doctor, nurse, emergency medical professional, coach, sports league administrator, insurance company or any third party with permission to receive the gathered sports injury data.

As demonstrated, medical personnel 40 may also communicate directly with recorder 10. Such communication may include, but not be limited, questions about injured person 15, directions for immediate care, directions for location of further care to be administered and the like. Once the line of communication is established, recorder 10 and medical personnel 40 may freely communicate back and forth until one party ends the communication or its necessity has ended.

### Examples

In one example herein the real time collection and storage of player injury data can be used to remove a player from gameplay that an opposing coach seeks to keep in a game improperly. If an opposing coach sees a player that demonstrates symptoms of concussion (e.g., the player is wobbly, incoherent, goes to the wrong huddle, sees stars, etc.) and referees do not see the injured player and/or opposing coaches for whom the player plays either do not recognize or refuse to recognize the symptoms, an opposing coach can log that player's injury in real time and request immediate attention of the player electronically thereby insuring that a potentially concussed player does not continue to play until properly evaluated.

In another example herein, a coach or parent can log a player's injury during practice. Because injuries happen often in the midst of a training or practice setting, such injuries often go missed. A parent who attends a practice session, if when an injury occurs, can log that injury in via the application on her smartphone in real time.

A player is injured in a game. A coach knows that she has had a player injured whenever a particular officiating crew officiates her games. She wonders whether there is a trend with this particular officiating crew. When she tracks her player's injury, she adds a field that collects the names of the officiating crew. All of this data is sent to the database. The coach then sends a request to the database to provide statistical information related to the incidence of injury with this particular officiating crew. Statistically relevant information is returned to the coach. The coach can then forward to that information to one or more relevant third parties that have accountability for the officiating crew in question.

A league organizer for youth lacrosse begins to create scheduling and assign referee crews for games in his league. He is concerned because insurance to play in his league has sharply increased. The insurance company bases such increase upon what the league organizer views as anecdotal evidence of increased injuries over the last five years in lacrosse for the age group that participates in the league organizer's league. The league organizer disputes this evidence for his league and suspects that the reverse is true. The league organizer places a request to the database to which injury data has been collected for the last five years using the invention herein. Statistically relevant data is transmitted to the league organizer that shows that not only have injuries not increased in his league, but they have in fact decreased and are lower than his state's average. The league organizer presents that data to the insurance carrier for his league which then adjusts the insurance premium required to be insured for lacrosse that year.

A parent has a son who is a quarterback. That quarterback is getting ready against a team that has a top ranked defensive end who is a senior and has been recruited by Michigan State. The parent is concerned about her son being injured in the game. The parent asks the system the following query: “What is the likelihood of injury resulting from player x in the game against Pinnacle Country Day school?” The system, by use of one or more algorithms, would examine injury data related to the defensive end (or at least his team) as against all others, injury data collected when said defensive end has played Pinnacle in the past, and the quarterback's own injury profile to provide an injury score, 1 to 10, of likelihood of injury for the quarterback.

A journalist has been tasked with the job of writing an article about the dangers of concussions in youth football. The journalist's editor reminds him to properly correlate such data to that of other popular youth sports; e.g., soccer, baseball, and lacrosse. The journalist agrees and makes several queries to the system that ask, essentially, to compare concussions in youth football at a state level or even nationally to that of soccer, baseball and lacrosse. The journalist surprisingly discovers that incidences of such concussions have occurred at the same rate or more in soccer and lacrosse as in football. The journalist then fashions his article into a concussion study across several youth related sports that informs and advises parents and interested third parties about the occurrence of concussions in popular youth sports.

A family is seeking a team for their daughter, a soccer player, to play soccer in the off season. The family is reviewing several teams which all have about the same reputation for performance. They use the system to collect injury related data for each of the head coaches of the teams. Coach A has an injury score of 3. Coach B has an injury score of 5. Coach C has an injury score of 8. The parents then select Coach A's team, with the lowest injury score, as the right team for their daughter.

A youth athlete seeks to choose a sport for the Fall. She doesn't know whether she wants to play girls soccer or girls volleyball. Her parents engage with her to determine the best sport for her. The athlete's parents are most concerned about the risk of injury for their daughter. They do not consider that her daughter as desirous or capable of playing sports at a scholarship level. The parents' and their daughter's desire is to be active and to play sports with her best friends in high school. The parents engage the system noted hereinabove through a laptop computer in their home. Using the system, they are able to make queries regarding all of the following:
Number of injuries in the previous year for girls soccer at their daughter's school;
Number of injuries in the previous year for girls volleyball at their daughter's school;
Percentage of players in the previous season for girls soccer and volleyball;
Type of serious injury incurred for athletes in the previous season for girls soccer and volleyball; and
Location of most severe injuries for either sport, whether in practice or in games.

Upon making the above queries, the inventive system provides near instantaneous output to the parents who are then able to think critically about the safest possible choice for their daughter to engage in sports for the Fall at minimally acceptable risk to her health.

An insurance company seeks to assign new rates for sports programming in a city. The insurer has a subscription to the system described herein whereby it can download injury data to its computers for review and analysis to a high degree of granularity. The insurer is tasked with assigning a mass rate to the city but also individual rates to each school. For each school that meets the average injury quotient, the general rate is to be applied. A school that exceeds the average injury quotient will be subject to the general rate plus a surcharge or additional rider to cover what is expected to be more injuries sports year for that school.

A hospital group in a certain city begins its planning for the next fiscal year. Their city has a high number rate of participation in youth sports. The hospital group suspects that it will need to hire more pediatricians specifically skilled in providing care for youth sport related injuries. To determine how many hires of that it should make of new medical staff (i.e., doctors, nurses, physical therapists), the hospital group engages the system discussed herein to examine youth injury data over the preceding five years. It makes queries to the system designed to examine whether such sports related injuries are trending upwardly or downwardly. It also makes queries to examine how serious to severe injuries are trending over the preceding five years. The hospital group will use this data to make hiring decisions and plot out the number of new medical staff should be placed within their various hospitals for this city.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for tracking and analyzing youth sports injuries of youth in real time, comprising:
a. A personal computer for collecting injury data;
b. A database wirelessly connected to said personal computer; and
c. An application on said personal computer, said application enabling the collection of said injury data into said database in real-time.

2. The system of claim 1 wherein said database comprises an algorithm.

3. The system of claim 2 wherein said algorithm organizes and classifies said injury data.

4. The system of claim 3 wherein said algorithm compares said injury data.

5. The system of claim 4 wherein said algorithm calculates statistically significant trends in said injury data.

6. The system of claim 1 wherein said system further comprises:
d. Contacting a health professional when said system collects and catalogs said injury data.

7. The system of claim 1 wherein said system further comprises:
d. Tracking the remediation and final disposition of said injury data.

8. The system of claim 1 wherein said system generates a schedule for the remediation of said injury.

9. The system of claim 1 wherein said personal computer is a smartphone.

10. The system of claim 1 wherein said personal computer is a smart pad device.

11. The system of claim 1 wherein said personal computer is a laptop computer.

12. The system of claim wherein said personal computer is a desktop computer.

13. The system of claim 1 wherein said injury data is connectable to a specific injured person.

14. The system of claim 1 wherein said collected injury data is transmitted to one or more third parties.

15. The system of claim 14 wherein said third party is a parent.

16. The system of claim 14 wherein said third party is a youth sports organization.

17. The system of claim 14 wherein said third party is a hospital.

18. The system of claim 14 wherein said third party is a designated health professional.

19. The system of claim 14 wherein said third party is a school.

20. The system of claim 14 wherein said third party is an insurance company.

21. The system of claim 14 wherein said third party is a research organization.

22. The system of claim 1 wherein said system aggregates, analyzes, benchmarks and tracks said injuries over time of said youth.

23. The system of claim 22 wherein said system creates a youth health profile for said youth.

24. The system of claim 1 wherein the context of said injury data is collected.

25. The system of claim 24 wherein said context includes, but is not limited to, age of said youth, gender of said youth, sport of said youth, date, surface, climate, humidity, temperature, game occurrence, practice occurrence, and activity during which said injury occurred.

26. The system of claim 1 wherein said collected injury data is immediately cross-referenced with any previously existing said injury data.

27. The system of claim 1 wherein said system comprises one or more algorithms for determining trends in injury data by multiple said injured youth.
